(19) United States
(12) Patent Application Publication
(10) Pub. No.: US 2024/0308850 A1
(43) Pub. Date: Sep. 19, 2024

(54) INTEGRATED ENERGY SYSTEMS FOR ENERGY PRODUCTION AND GREEN INDUSTRIAL APPLICATIONS, SUCH AS THE PRODUCTION OF NITRIC ACID

(71) Applicant: NuScale Power, LLC, Corvallis, OR (US)

(72) Inventors: Francis Y. Tsang, Bellingham, WA (US); José N. Reyes, Jr., Corvallis, OR (US)

(21) Appl. No.: 18/606,962

(22) Filed: Mar. 15, 2024

Related U.S. Application Data
(60) Provisional application No. 63/453,018, filed on Mar. 17, 2023.

(51) Int. Cl. C01B 21/38; C01B 3/02; C25B 1/042

(52) U.S. Cl. CPC C01B 21/38; C01B 3/025; C25B 1/042; C01B 2203/02

(57) ABSTRACT

Described herein are techniques that may be performed in an Integrated Energy System (IES) to produce Nitric Acid (HNO₃) while minimizing a carbon footprint. Such techniques, as performed by a resource production plant, may comprise receiving electricity and steam from a power plant to produce Hydrogen (H₂) gas from the steam at a Hydrogen (H₂) production sub-plant, receiving electricity from the power plant and air from the environment to produce Nitrogen (N₂) gas at a Nitrogen (N₂) production sub-plant, producing Ammonia (NH₃) from the Hydrogen (H₂) gas and the Nitrogen (N₂) gas at a nitrogen production sub-plant, and producing Nitric Acid (HNO₃) from the Ammonia (NH₃) at a Nitric Acid (HNO₃) production sub-plant.

### CROSS-REFERENCE TO RELATED APPLICATIONS

This application claims the benefit of U.S. Provisional Patent Application No. 63/453,018, filed Mar. 17, 2023, and titled “SMALL MODULAR NUCLEAR REACTOR INTEGRATED ENERGY SYSTEMS FOR ENERGY PRODUCTION AND GREEN INDUSTRIAL APPLICATIONS, SUCH AS THE PRODUCTION OF NITRIC ACID” which is incorporated herein by reference in its entirety.

### TECHNICAL FIELD

The present technology is directed to nuclear reactor integrated energy systems (IESs) for energy production and green industrial applications, such as the production of green Nitric Acid and associated devices and methods.

BACKGROUND

The energy production landscape has evolved rapidly in recent years, with a growing emphasis on decarbonization, sustainability, and resilience, driving the adoption of cleaner and more efficient forms of power production. While fossil fuels continue to play a significant role in global energy supply, there is a clear trend toward increased deployment of renewable energy, coupled with advancements in energy storage, grid modernization, and energy efficiency measures, to address the challenges of climate change and energy transition.

Cumulative carbon dioxide emissions are the dominant driver of climate change. The seven largest CO₂ emission industries in the world are: (1) power plants (coal, natural gas, oil fired), (2) oil refinery plants, (3) ammonia production plants, (4) chemical manufacturing and production plants, (5) cement production plants, (6) steel manufacturing plants, and (7) transportation. Many of these processes, as well as others in the petroleum, chemical, pharmaceutical, and material manufacturing industries require a combination of electrical power, steam, heat, and Hydrogen (H₂) to operate and to produce industrial products. For example, Hydrogen (H₂) is used in each of the above industries (2)-(7). Currently, most of the Hydrogen (H₂) produced in the United States comes from steam-methane reforming processes. In the United States, steam-methane reforming processes accounted for more than 95% of all Hydrogen (H₂) production and produced about 10 million metric tons (MT) of H₂ each year. Nearly 70% of this hydrogen is used in the petroleum refining industry, and 20% is used for fertilizer production. The remaining 10% is used in chemical and material production processes.

An energy system incorporates various energy conversion technologies, such as power plants, cogeneration (combined heat and power) systems, and distributed generation units (such as solar panels and wind turbines). These technologies convert primary energy sources into usable forms of energy, such as electricity, heat, and mechanical power that can be used as secondary energy sources. Energy systems leverage a diverse range of energy resources, including renewable energy sources (such as solar, wind, and hydroelectric power), conventional fuels (such as natural gas and coal), and emerging technologies (such as hydrogen and biofuels). By combining multiple energy sources, these systems can enhance energy security and resilience.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of an integrated energy system that includes a power plant system in accordance with at least some embodiments.

FIG. 2 depicts a block diagram illustrating an example hydrogen production process for producing hydrogen gas, in accordance with at least some embodiments.

FIG. 3 is a schematic diagram of a typical HTSE electrolytic separator.

FIG. 4 depicts a block diagram illustrating an example ammonia production process in accordance with at least some embodiments.

FIG. 5 depicts a block diagram illustrating an example Nitric Acid production process of the Nitric Acid production sub-plant for producing Nitric Acid, in accordance with at least some embodiments.

FIG. 6 is a schematic diagram of an integrated energy system including a power plant system, in accordance with additional embodiments of the present technology.

FIG. 7 is a schematic view of a nuclear power plant system including multiple nuclear reactors in accordance with embodiments of the present technology.

FIG. 8 is a partially schematic, partially cross-sectional view of a nuclear reactor system configured in accordance with embodiments of the present technology.

FIG. 9 is a partially schematic, partially cross-sectional view of a nuclear reactor system configured in accordance with additional embodiments of the present technology.

FIG. 10 illustrates an example process for producing Nitric Acid, in accordance with additional embodiments of the present technology.

### DETAILED DESCRIPTION

In embodiments, the disclosure is directed to techniques that may be performed in relation to Integrated Energy Systems (IESs), such as for use in green industrial processes that produce few or no carbon emissions, and associated devices and methods. IESs of the present technology may include a power plant (e.g., a primary power plant) that is integrated with one or more resource production plants. Resource production in accordance with embodiments of the present technology may include industrial processes, applications, and operations such as chemical manufacturing and production, petroleum and oil refinery, cement production, steel manufacturing, transportation, pharmaceutical production, and materials manufacturing. Chemical manufacturing and production may include the production of, for example, Hydrogen (H₂), Oxygen (O₂), Nitrogen (N₂), Ammonia (NH₃), Nitric Acid (HNO₃), as well as other chemicals that may be used in industrial applications. Such an IES may be capable of producing a resource using excess power and steam from the power plant.

In some embodiments, an integrated energy system includes a power plant system having multiple small modular nuclear reactors (SMRs) specifically configured to operate in unison to support one or more of the industrial processes. SMRs are nuclear reactors that are smaller in terms of size (e.g., dimensions) and power compared to large, conventional nuclear reactors. Moreover, they are modular in that some or all of their systems and components can be factory-assembled and transported as a unit to a location for installation. In some aspects of the present technology, the multiple SMRs of the integrated energy system can flexibly and dynamically provide electricity, steam, or a combination of both electricity and steam to the industrial processes due to the modularity and flexibility of the SMRs. That is, a configuration of the SMRs can be switched during operation to provide varying levels of steam and electricity output depending on the operational states and/or demands of the industrial processes.

Because of the drive toward cleaner and more efficient forms of power production, nuclear power will be increasingly important in the coming years. Nuclear power plants provide reliable baseload power and produce minimal greenhouse gas emissions during operation, making them attractive for countries that are seeking to reduce carbon emissions and enhance energy security. For example, nuclear power plants produce electricity without emitting greenhouse gases such as carbon dioxide (CO₂) during operation. In operation, nuclear power plants use nuclear fission to generate heat, which is then used to produce steam to turn turbines and generate electricity. This process can result in the production of both electrical power and steam. Managing and disposing of waste steam from nuclear power plants can be challenging. Therefore, there is a need to address the challenges of climate change by reducing CO₂ emissions in industrial processes, as in the production of H₂ specifically. Due to the advantages of nuclear energy for providing steam, electricity, and heat, there is also a need to develop methods of using nuclear power in integrated energy systems.

In some embodiments, the power plant system is operably coupled to a Hydrogen (H₂) and Oxygen (O₂) production plant configured to process water and/or steam to produce hydrogen and oxygen. The Hydrogen (H₂) and Oxygen (O₂) production plant can utilize a high temperature steam electrolysis (HTSE) process and/or low temperature steam electrolysis (LTSE) process. Accordingly, the power plant system can route (i) high temperature steam (e.g., via an auxiliary heater) and electricity to the Hydrogen (H₂) and Oxygen (O₂) production plant for use in the HTSE process and (ii) electricity to the Hydrogen (H₂) and Oxygen (O₂) production plant for use in the LTSE process. In some embodiments, the integrated energy system includes a water treatment plant and/or water desalination plant electrically coupled to the power plant system and configured to provide high-quality water to the Hydrogen (H₂) and Oxygen (O₂) production plant for use in the LTSE process.

Accordingly, the integrated energy system can produce both green Hydrogen (H₂) and green Oxygen (O₂). The integrated energy system can further include additional industrial process plants operably coupled to the power plant system and configured to utilize the green Hydrogen (H₂) and/or green Oxygen (O₂) in further industrial processes. For example, the integrated energy system can further include (i) an ammonia production plant configured to utilize the green Hydrogen (H₂) and Nitrogen (N₂) from the environment (e.g., Nitrogen (N₂) pulled from the air by a Nitrogen (N₂) generator, typically it is called Pressure Swing Adsorption (PSA) system) to produce green ammonia, and (ii) a Nitric Acid production plant configured to utilize the green ammonia to produce Nitric Acid. The power plant system can further power some or all of these additional processes.

Nitric Acid (HNO₃, also known as aqua fortis and spirit of niter) is an important industrial chemical for the manufacture of fertilizers. The global Nitric Acid market size is projected to grow from $28.23 billion in 2021 to $34.76 billion by 2030, and over 75% of the market is the production of fertilizers. Nitric Acid is used as an intermediate in the manufacture of ammonium nitrate (NH₄NO₃), which is primarily used in agriculture as a high-nitrogen fertilizer.

The pure Nitric Acid compound is colorless, but older or low-quality samples tend to have a yellow cast due to nitrogen oxides (NO_{X}) impurities and water. Most commercially available Nitric Acid has a concentration of 68% (v/v) in water. When the solution contains more than 86% (v/v) Nitric Acid, it is referred to as fuming Nitric Acid, which, depending on the amount of nitrogen dioxide (NO₂) present, is further characterized as (i) white fuming Nitric Acid or (2) red fuming Nitric Acid at concentrations above 95%.

Today, Nitric Acid is almost entirely produced via the oxidation of ammonia and absorption of the oxidation products in water. The chemistry of this process was proven experimentally by Charles Frédéric Kuhlmann in 1839. In about 1900 Wilhelm Ostwald developed and patented the Ostwald process by extending Kuhlmann's data to establish the proper conditions required for the ammonia oxidation step.

Oxidation is a process in which a chemical substance changes because of the addition of Oxygen (O₂). Air, or more precisely the oxygen in air, is generally used for Ammonia (NH₃) oxidation in the production of Nitric Acid because air is inexpensive and readily available. Air comprises about 21% oxygen, 78% nitrogen, and about 1% argon and carbon dioxide. Using air as an oxidizer instead of pure oxygen, however, is not as efficient and creates more undesired reaction byproducts, impurities, and pollution as a result. The addition of pure oxygen to a standard Nitric Acid production process that use air as the primary oxidizer can boost Nitric Acid production along with controlling NO_{X} and increasing acid strength and reducing impurities, as described in EP0808797A2. Further advantages of using pure oxygen in the oxidation of ammonia include higher yield reactions, pollution control and reduction in NO_{X} emissions. The high cost of pure oxygen and the energy requirements for its production, however, have made oxygen injection nonviable in practice.

In practice today, most production of oxygen gas uses fossil fuels satisfy the energy requirements for the process, resulting in greenhouse gas emissions and a non-carbon neutral process. Industrial oxygen plants typically use air as a feedstock and separate it from other components of air by using various techniques such as pressure swing adsorption or membrane separation techniques. These techniques, however produce relatively difference in oxygen purities and concentrations, 93-95% for adsorption systems and 30-45% for membrane plants. Currently, these methods have limited capacity and high-power consumption. These techniques also require input of large amounts of natural gas.

The production of ammonia is also highly energy intensive and contributes to a significant amount of CO₂ due to the production of Hydrogen (H₂) via steam-menthane-reforming. Combined with the energy needed to produce Hydrogen (H₂) and purified atmospheric Nitrogen (N₂), Ammonia (NH₃) production accounts for 1% to 2% of global energy consumption, 3% of global carbon emissions, and 3% to 5% of natural gas consumption. Hydrogen (H₂) required for Ammonia (NH₃) synthesis is most often produced through gasification of carbon-containing material, mostly natural gas, but other potential carbon sources include coal, petroleum, peat, biomass, or agriculture wastes. As of 2012, the global production of Ammonia (NH₃) produced from natural gas using the steam reforming process was 72%.

In order to address the challenges of climate change, reduce CO₂ emissions, and reduce pollution and industrial byproducts in the production high yield chemicals such as Nitric Acid (HNO₃), there is a need to develop a system and method of producing green Hydrogen (H₂), Oxygen (O₂), Ammonia (NH₃), Nitrogen (N₂), and Nitric Acid (HNO₃) that generate few or no carbon emissions.

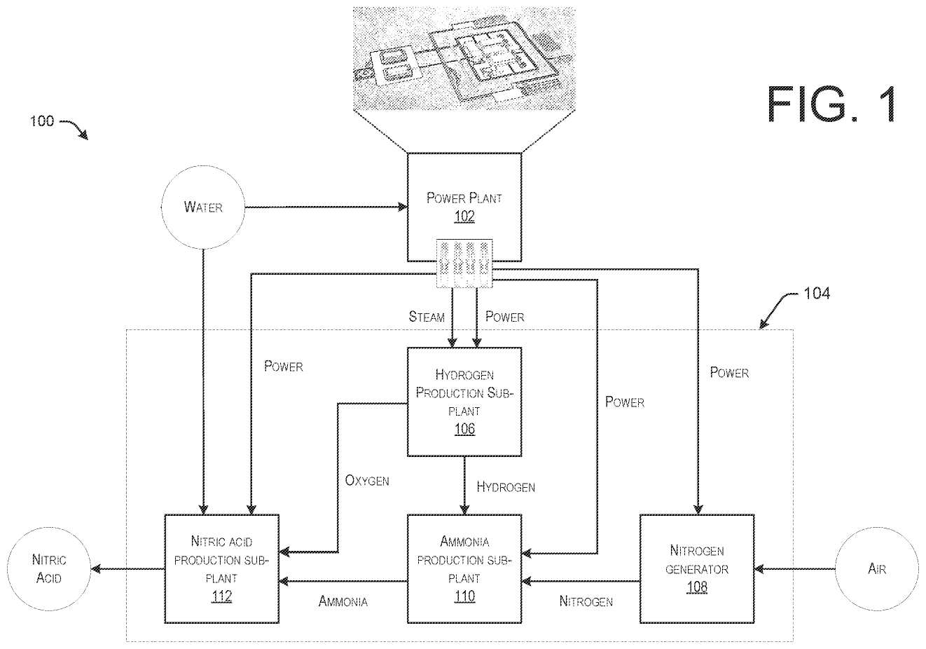

Certain details are set forth in the following description and in FIGS. 1-10 to provide a thorough understanding of various embodiments of the present technology. In other instances, well-known structures, materials, operations, and/or systems often associated with nuclear reactors, power plant systems, integrated energy systems, chemical production plants, industrial process plants, electrolysis systems, hydrogen and oxygen production plants, direct air capture (DAC) plants, oil refineries, and the like, are not shown or described in detail in the following disclosure to avoid unnecessarily obscuring the description of the various embodiments of the technology. Those of ordinary skill in the art will recognize, however, that the present technology can be practiced without one or more of the details set forth herein, and/or with other structures, methods, components, and so forth. The terminology used below is to be interpreted in its broadest reasonable manner, even though it is being used in conjunction with a detailed description of certain examples of embodiments of the technology.

The accompanying Figures depict embodiments of the present technology and are not intended to limit its scope unless expressly indicated. The sizes of various depicted elements are not necessarily drawn to scale, and these various elements may be enlarged to improve legibility. Component details may be abstracted in the Figures to exclude details such as position of components and certain precise connections between such components when such details are unnecessary for a complete understanding of how to make and use the present technology. Many of the details, dimensions, angles and other features shown in the Figures are merely illustrative of particular embodiments of the disclosure. Accordingly, other embodiments can have other details, dimensions, angles and features without departing from the present technology. In addition, those of ordinary skill in the art will appreciate that further embodiments of the present technology can be practiced without several of the details described below.

To the extent any materials incorporated herein by reference conflict with the present disclosure, the present disclosure controls. The headings provided herein are for convenience only and should not be construed as limiting the subject matter disclosed.

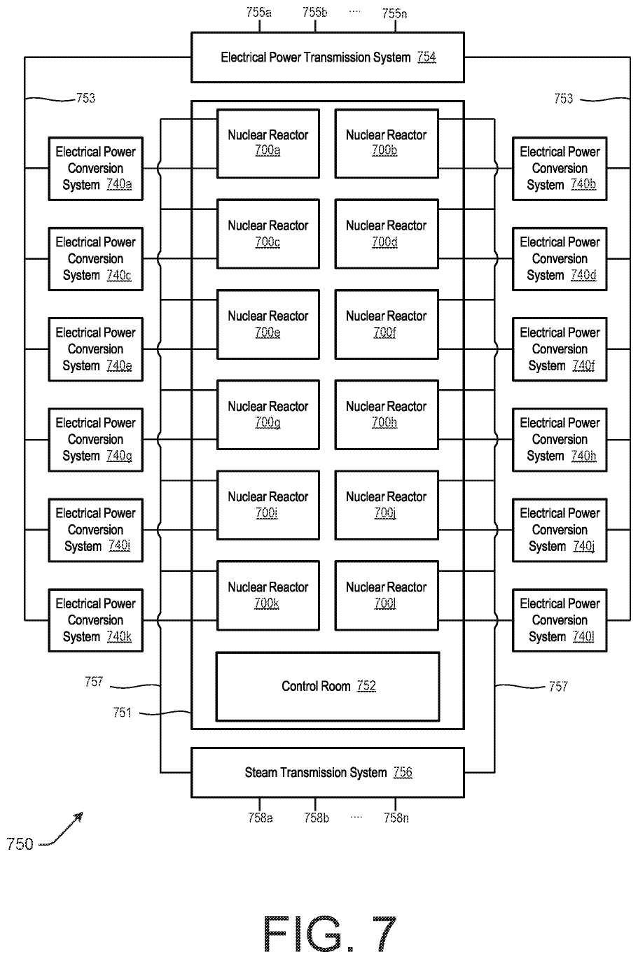

FIG. 1 is a schematic diagram of an integrated energy system (IES) 100 that includes a power plant 102 in accordance with at least some embodiments. For example, the power plant 102 may include the power plant system 750 of FIG. 7, in accordance with additional embodiments of the present technology. In the illustrated embodiment, the power plant 102 is configured for use in one or more industrial processes/operations and, more particularly, for use in resource production/recovery operations. The power plant 102 can be located at or near the location of a resource production plant 104. The resource production plant 104 may include one or more chemical production processes and industrial processes/operations that produce resources. For example, the power plant 102 can be a permanent or temporary installation built at or near (e.g., roughly 1 km from) the location of the resource production plant 104, or can be a mobile or partially mobile system that is moved to and assembled at or near the location of the resource production plant 104. More generally, the power plant 102 can be local (e.g., positioned at or near) the industrial processes/operations it supports. For example, the power plant 102 can be located within 0.4 km (0.25 mile), within 0.8 km (0.5 mile), within 3.22 km (2 miles), within 4.82 km (3 miles), or within 8.1 km (5 miles) of the industrial processes/operations it supports. In some embodiments, the power plant 102 includes four, six, twelve, or a different number of the nuclear reactors and has a power output of between 308-924 megawatts electrical (MWe). In some embodiments, the power plant 102 can output between about 308-924 MWe and between about 1000-3000 megawatts thermal (MWt).

In the illustrated embodiment, the power plant 102 is operably coupled to a water source. The water source may include water from a storage tank, a reservoir, a river, a lake, an ocean, groundwater, a well or the like. Water from the water source may be high-quality water, in that such water is relatively free from impurities. Water from the water source may be fed to a water treatment plant to produce high-quality water. The water treatment plant can be a water treatment plant, a desalination plant, and/or the like and is configured to produce high-quality water that can be provided to the power plant 102 for use in power generation/cooling. For example, the water treatment plant can operate to demineralize and/or otherwise remove contaminants and/or unwanted material from a water source. Water treatment may include at least one purification method, such as reverse osmosis, electrodialysis, distillation, desalination, deionization, filtration, ultrafiltration, or nanofiltration. In general, the water treatment plant can require a significant amount of energy to operate. In some aspects of the present technology, the power plant 102 can be electrically coupled to the water treatment plant and configured to flexibly and reliably deliver electricity to the water treatment plant.

The water treatment plant can route the produced high-quality water to the power plant 102, and the power plant 102 can use the water to produce power along with a byproduct of high-quality steam. In contrast to limitations in conventional technology that include a lack of any solution utilizable for efficiently processing the sourced water (e.g., brine), the power plant 102 can utilize the SMRs to efficiently, and without emissions (e.g., carbon emissions), generate the clean, high-quality water. The clean water being produced may be suitable for various downstream operations. For example, the power plant 102 can utilize the SMRs to generate the clean water, which can be utilized, for example, for electrolysis, as discussed below in further detail. In alternative or additional examples, the produced water can be used as a secondary coolant in a steam generator of one or more of the nuclear reactors. In some embodiments, the water treatment plant can be omitted and the power plant 102 can utilize water from other sources to generate steam.

In embodiments, the power plant 102 can be electrically coupled to the water treatment plant, the resource production plant 104, and a power grid for selectively providing electricity (e.g., power) thereto (e.g., via one or more of the electrical output paths from an electrical power transmission system of the power plant system). Similarly, individual steam output paths from the power plant 102 can be fluidly coupled to the resource production plant 104 for selectively providing steam thereto. In other embodiments, the power plant 102 can be operably coupled to additional or fewer outputs and/or the various outputs can receive electricity and/or steam from other sources (e.g., conventional steam generators, conventional electricity sources, etc.).

In embodiments, in which the power plant 102 provides steam and power to the resource production plant 104, the resource production plant 104 may use the combination of steam and power to produce a specific resource. Resources may include chemicals such as hydrogen, oxygen, nitrogen, ammonia, and Nitric Acid (HNO₃). For example, the power plant 102 and the resource production plant 104 may act as a closed-loop system to generate the resources. In such cases, the amount of steam and power provided to the resource production plant 104 may be catered to achieve a specified production level for the resource. For example, the amount of power and steam directed to the resource production plant 104 may be an amount needed to produce a predetermined amount of the resource, which may then be stored. In some cases, steam provided by the power plant 102 is condensed into liquid water during the resource production process and subsequently returned to the power plant 102 (in some cases via a water treatment plant).

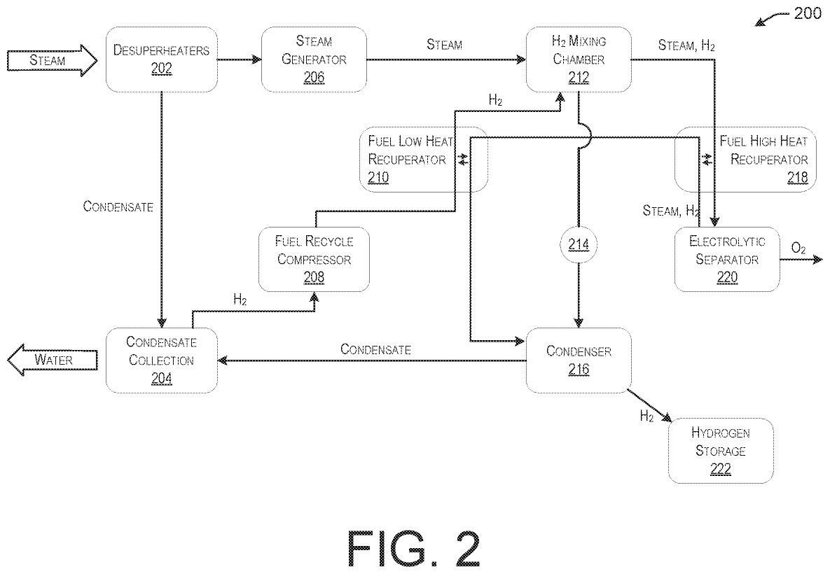

The resource production plant 104 may include a hydrogen production sub-plant 106 that produces hydrogen from steam. In embodiments, the steam may be provided by the power plant 102. The hydrogen production sub-plant 106 may perform the hydrogen production process 200 of FIG. 2 described in detail below, in accordance with additional embodiments of the present technology.

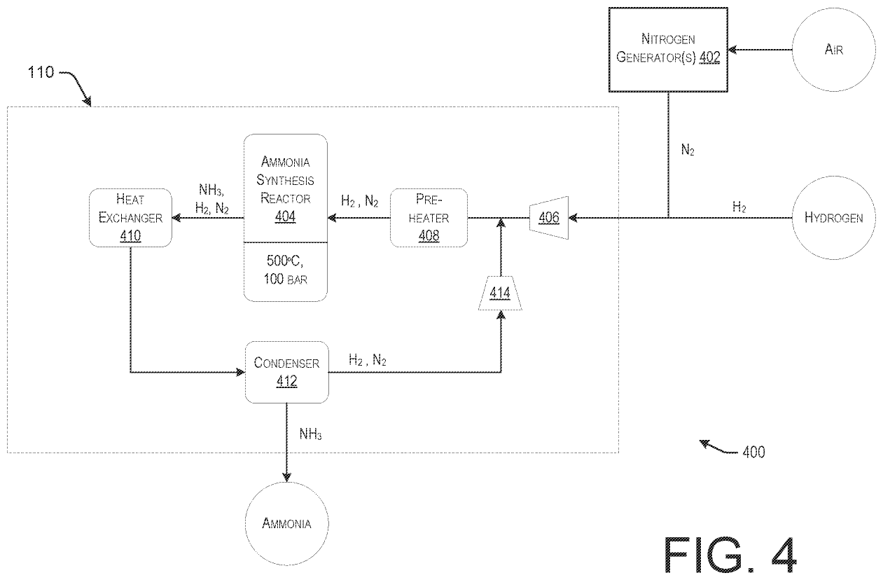

The resource production plant 104 may include an ammonia production sub-plant 110 that produces ammonia by combining hydrogen from the hydrogen production sub-plant 106 with nitrogen pulled from ambient air. The ammonia production sub-plant 110 may include the ammonia production process 400 of FIG. 4 described in detail below, in accordance with additional embodiments of the present technology.

The resource production plant 104 may include a nitrogen generator 108 that is configured to pull nitrogen from ambient air. The nitrogen generator 108 may include the nitrogen generator 402 of FIG. 4 described in detail below, in accordance with additional embodiments of the present technology.

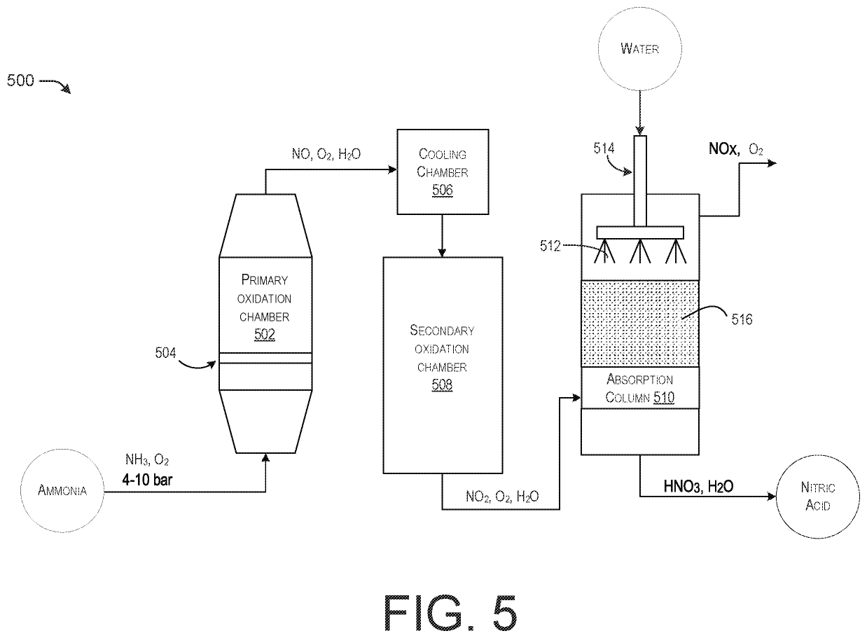

The resource production plant 104 may include a Nitric Acid (HNO₃) production sub-plant 112 that produces Nitric Acid (HNO₃) from the ammonia. The Nitric Acid (HNO₃) production sub-plant 112 may include the Nitric Acid (HNO₃) production process 500 of FIG. 5 described in detail below, in accordance with additional embodiments of the present technology.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

In various implementations, the power plant 102 and the resource production plant 104 (e.g., the hydrogen production sub-plant 106, nitrogen generator 108, the ammonia production sub-plant 110, the Nitric Acid (HNO₃) production sub-plant 112, and/or one or more other portions of the IES 100) can be operated in one or more of various modes (e.g., various states, such as one or more control states). In some examples, the power plant 102 and the resource production plant 104 (e.g., the hydrogen production sub-plant 106, nitrogen generator 108, the ammonia production sub-plant 110, the Nitric Acid (HNO₃) production sub-plant 112, and/or one or more other portions of the IES 100) can be operated in a first mode in which Nitric Acid (HNO₃) is not being produced. In those or other examples, the power plant 102 and the resource production plant 104 (e.g., the hydrogen production sub-plant 106, nitrogen generator 108, the ammonia production sub-plant 110, the Nitric Acid (HNO₃) production sub-plant 112, and/or one or more other portions of the IES 100) can be operated in a second mode in which Nitric Acid (HNO₃) is being produced. For instance, in the second mode, the Nitric Acid can be produced utilizing the Nitric Acid (HNO₃) production process 500.

In various implementations, individual SMRs can be operated in the various mode(s). For example, one SMR may be operated in a steam production mode utilized for the Nitric Acid (HNO₃) production, while another SMR is operated in an electrical power generation mode to supply power to system with the Nitric Acid (HNO₃) production-oriented SMR, and/or to one or more other plants/systems/components. Additionally or alternatively, one of the SMRs may produce both power and steam. The SMRs may switch from one mode to another, and/or be utilized interchangeably and/or in cooperation with one another.

In some examples, the power plant 102 and/or one or more portions of the resource production plant 104 can be controlled based on various types of one or more operation/control modes utilized for the power plant 102 (e.g., for the SMRs). The SMRs can be controlled in the mode(s) to produce different types (e.g., levels) of power and/or steam. The type(s) of power and/or steam can be utilized for different purposes and/or applications. For example, the type(s) of power and/or steam can be utilized, based on the respective mode(s), for providing specific amounts of power to an electrolyzer, sending specific amounts of steam to the resource production plant 104, providing specific amounts of power to one or more other plants/systems, sending specific amounts of steam to one or more other plants/systems, or any combination thereof.

In various implementations, a production plant that includes the power plant 102 and the resource production plant 104 (e.g., the hydrogen production sub-plant 106, nitrogen generator 108, the ammonia production sub-plant 110, the Nitric Acid (HNO₃) production sub-plant 112, and/or one or more other plants/systems of the IES 100), and possibly one or more other plants/sub-plants/systems/sub-systems configured to utilize the Nitric Acid (HNO₃), can be located on the same premises. For instance, any of the plants/sub-plants/systems/sub-systems of the production plant can be co-located (e.g., located within a threshold distance from each other). Any of the plants/sub-plants/systems/sub-systems of the production plant can be fully integrated and/or interconnected with one another.

The production plant according to the techniques discussed herein has many advantages over plants/systems being operated according to conventional technology. Conventional plants/systems that utilize Nitric Acid (HNO₃) have relatively significant inefficiencies and operation costs due to safety measures that are required and/or operation constraints/limitations. Plants/systems utilized for production of electricity, steam, and/or Nitric Acid (HNO₃) according to conventional technology are required to be physically separate from one another. Existing systems producing Nitric Acid (HNO₃) require shipment, often over long distances between different parts of the country and/or world, of nitrogen from nitrogen production facilities/suppliers. Existing systems producing Nitric Acid (HNO₃) require natural gas to generate the Nitric Acid (HNO₃). Existing Nitric Acid (HNO₃) production facilities do not have hydrogen production capabilities for purposes of generating the Nitric Acid (HNO₃). Existing Nitric Acid (HNO₃) production facilities also require shipment of oxygen.

In contrast to the existing systems, the production plant according to the techniques discussed herein does not require resources (nitrogen, oxygen, etc.) to be transported between plants. The production plant according to the techniques discussed herein can be integrating and/or interconnected. The production plant, which can be an in-situ plant that is operated via on-grid or off-grid operation, can be self-contained and compact. The production plant can include a single hydrogen, oxygen, ammonia, and Nitric Acid (HNO₃) production plant.

The production plant can just grab resources, such as hydrogen and oxygen, from the air or from water, and utilize the resources for Nitric Acid (HNO₃) production. The Nitric Acid (HNO₃) can be produced by the production plant without requiring input of natural gas. The production plant can customize its output to produce Nitric Acid (HNO₃) at any specified concentration of Nitric Acid (HNO₃), as desired. The integrated and/or integrated plants/systems of the production plant can be utilized for efficiently, cost-effectively, safely producing electricity, steam, and/or Nitric Acid (HNO₃) with no carbon emissions. No carbon dioxide is emitted by the production plant. By avoiding shipments of the various resources (nitrogen, oxygen, etc.), the production plant according to the techniques discussed herein also eliminates pollution otherwise resulting from vehicle emissions generated for operation of existing systems.

FIG. 2 depicts a block diagram illustrating an example hydrogen production process 200 for producing hydrogen gas, in accordance with at least some embodiments. In some cases, the hydrogen production process 200 may include the hydrogen production sub-plant 106 of FIG. 1. In some cases, the hydrogen production process 200 produces hydrogen gas using steam and power generated by the power plant 102. For example, in an exemplary process for producing H₂, steam may be provided at 30.33 bar (440 psia) as well as at 280° C. (537° F.). In such cases, the power plant 102 may be located some distance from the hydrogen production sub-plant 10 (e.g., 1 km). Accordingly, the steam may be provided via at least one supply pipe that is insulated to maintain proper steam conditions.

In the exemplary hydrogen production process 200, steam is received and initially fed to desuperheater components 202 in order to restore the superheated steam to its saturated state. Particularly, the steam is first fed to a high-pressure desuperheater component. The steam exiting the high-pressure desuperheater component is throttled to 8.34 bar (121 psia). This steam enters a separator to collect and drain any condensate. The condensate will drain to a condensate collection tank 204, to be provided back to the power plant 102 (e.g., by way of a water treatment plant). The throttled steam will next enter a low-pressure desuperheater. In the hydrogen production process 200, steam exiting the low pressure desuperheater will be close to saturation temperature.

During the hydrogen production process 200, the condensate collection tank 204 should start with enough water to support H₂ production. The level of water in a condensate collection tank 204 should be maintained at roughly 50% capacity. During operation, the tank is maintained at a particular pressure, e.g., 7 bar (101.5 psia) and a control valve is used to drain the tank to maintain that level. If the tank level goes above a high setpoint, two condensate forwarding pumps may be used to help in draining the tanks. One or more of such pumps may auto-start if a level of water in the condensate collection tank 204 is above a first threshold capacity. In such cases, the pump may also auto-stop when the level of water in the condensate collection tank 204 is below a second threshold capacity.

The steam exiting the desuperheater components 202 will enter a steam generator (boiler) 206. The steam generator 206 is configured to condition the steam in order to provide steam to downstream process components at a particular pressure and/or temperature. For example, the steam generator 206 may provide steam at 5.17 bar (75 psia) and 228° C. (442° F.). The steam generator 206 provides steam to a H₂ mixing chamber 212.

In some embodiments, H₂ gas is pulled from the condensate collection tank 204 by a fuel recycle compressor 208 and is forwarded to the fuel low heat recuperator 210. The fuel recycle compressor 208 should be in service when the hydrogen production process 200 is initiated. During the hydrogen production process 200, an outlet valve can be modulated to control the recycle fuel flow and maintain the concentration of H₂ and steam entering a downstream electrolytic separator 220 at a 50/50 by volume ratio. The H₂ gas forwarded by the fuel recycle compressor 208 enters the fuel low-heat recuperator 210. The H₂ gas may be heated (via a heat exchange) by the “hot side” gases that are being conveyed to the condenser.

H₂ gas exiting the fuel low heat recuperator 210 enters a H₂ mixing chamber 212. In the hydrogen production process 200, the mixture of steam and H₂ is controlled to maintain a proportion of 50% steam and 50% H₂ by volume. A steam flow control valve is used to admit steam from the steam generator 206 to maintain this concentration. In local control, the steam flow setpoint may be calculated based on the amount of H₂ flow entering the H₂ mixing chamber 212 (e.g., in order to maintain the H₂ concentration at 50% by volume). The setpoint may also maintain a minimum level of steam flow.

A steam bypass valve 214 is used to control the steam pressure at the H₂ mixing chamber 212. During module startup, the steam generator 206 pressurizes the steam to 5.2 bar (75.5 psia) and steam flow is bypassed to the condenser 216 using the bypass control valve 214. When the hydrogen production process 200 is in operation, the pressure setpoint for the bypass control valve 214 can then be raised to allow the bypass control valve 214 to close during this operation. This also allows the bypass control valve 214 to serve as a pressure relief valve/steam overflow control.

The mixture of steam and H₂ is fed by the H₂ mixing chamber 212 to a fuel high-heat recuperator 218. In some embodiments, the steam and H₂ mixture is heated (via a heat exchange) by “hot side” gases leaving one or more electrolytic separators 220 that are being conveyed to the condenser 216. The steam and H₂ mixture then enter an electric heater. The electric heater has a variable heat output and is used to control the temperature of the mixture to a specific temperature, e.g., 750° C. (1382° F.). If the temperature of the mixture goes above a high setpoint threshold, e.g., 788° C. (1450° F.), the heater will turn off. The electric heater of the fuel high-heat recuperator 218 should only be in operation if there is flow passing through it.

The mixture of steam and H₂ exiting the electric heater of the fuel high-heat recuperator 218 then enters one or more electrolytic separators 220. A processor for the electrolytic separator 220 may calculate the electro-chemistry based on one or more detected conditions of the steam and H₂ mixture. As noted elsewhere, the one or more detected conditions of the steam and H₂ mixture may be determined based on information obtained using sensors coupled to various components. For example, such sensors may obtain information that pertains to a temperature, a pressure, and/or a voltage associated with the mixture.

The oxygen (e.g., O₂) produced in this manner may be stored and/or used in a downstream system. In some cases, the O₂ is combined with another element to create an oxide that can be used in fuel cells, such as solid oxide fuel cells (SOFC). Such fuel cells can be later used to generate electrical power through the oxidization of fuel (e.g., H₂ gas as produced via the process 200).

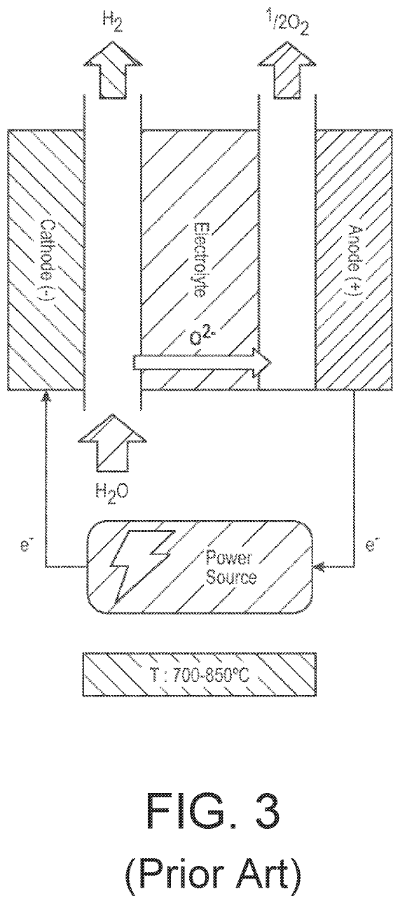

In the hydrogen production process 200, steam (H₂O) is dissociated into hydrogen and oxygen molecules. In some cases, this may involve the use of a high temperature steam electrolysis (HTSE) process. HTSE cells are extremely efficient when the input steam temperature is maintained between 700 to 850° C. FIG. 3 is a schematic diagram of a typical HTSE electrolytic separator in which the inlet steam temperature is to be maintained between 700-850° C. Referring to FIG. 3, the representative HTSE cell is a solid-state construction (ceramic and metal) and high operating temperature. The combination of these features leads to several distinctive and attractive attributes including cell and stack design flexibility, multiple fabrication options, and multi-fuel capability choices. The hydrogen molecules remain on the fuel-side of the electrolytic separator 220, while the oxygen molecules are pulled through a cell ceramic. The mass flow exiting the fuel side will be less than the mass flow entering. Additionally, while the steam and H₂ mixture entering the electrolytic separator 220 will have a 50/50 ratio, the steam and H₂ mixture exiting the electrolytic separator 220 will be 75% H₂ by volume.

The steam and H₂ mixture exiting the electrolytic separator 220 and enters the “hot side” of the fuel high-heat recuperator 218. As noted above, heat is exchanged between this steam and H₂ mixture (i.e., the 75% H₂ mixture) and the steam and H₂ mixture exiting the H₂ mixing chamber 212 (i.e., the 50/50 mixture). Hence, the 75% H₂ mixture is cooled and then enters the “hot side” of the fuel low heat recuperator 210. As noted above, heat is then exchanged between this steam and H₂ mixture and the H₂ gas exiting the fuel low-heat recuperator 210 to further cool the steam and H₂ mixture. The steam and H₂ mixture is subsequently fed into the condenser 216.

The condenser 216 allows the water within the steam and H₂ mixture to condense into liquid form, which is subsequently drained into the condensate collection tank 204. Once the steam in the mixture has been condensed into water, the remaining volume of gas will be almost 100% H_{2.} The H₂ gas exiting the condenser 216 may be pumped into a hydrogen storage tank 222. The H₂ gas stored in the hydrogen storage tank 222 may then be consumed by another entity (e.g., by the ammonia production sub-plant 110 to produce ammonia).

In embodiments, H₂ gas stored in the hydrogen storage tank 222 is stored at 689+ bar (10,000+ psia). When consumed during an ammonia production process, hydrogen may be admitted through an expansion tank to reduce pressure (e.g., expand) to a useable level. e.g., between 60-180 bar. In such embodiments, a flow control valve is used to control the flow from the outlet of the H₂ expander to the inlet of the fuel low heat recuperator 210.

Inter-stage control valves of the H₂ expander can be used to control a downstream hydrogen storage tank to store H₂ gas at 6.9 bar (100 psia). Each stage of the expansion tank has an inlet valve and a bypass valve. As the pressure in that hydrogen storage tanks drops, the inlet stage of the compressor will shift down in stages. The upstream stage inlet valve will close, and the new inlet stage bypass will open.

In embodiments, each of a number of stages in the expansion tank has an electric heater to maintain temperature between stages. As the H₂ pressure continues to be reduced (e.g., expanded), there is a significant temperature drop. Hence, the heaters will maintain the temperature between stages at 40° C. (104° F.).

FIG. 4 depicts a block diagram illustrating an example ammonia production process 400, in accordance with at least some embodiments. In some cases, the ammonia production process 400 may include the ammonia production sub-plant 110 of FIG. 1. In accordance with embodiments of the present technology, the ammonia production process 400 may produce ammonia according to chemical principles that achieve the function of combining hydrogen with the nitrogen pulled from ambient air to form ammonia. For example, the ammonia production process 400 may include the Haber-Bosch process.

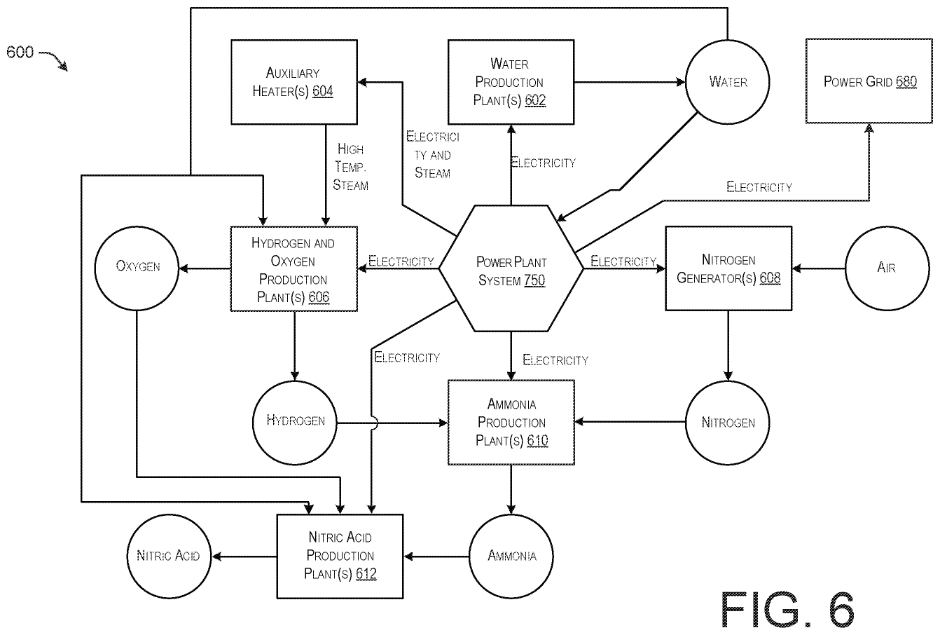

The ammonia production process 400 may include a nitrogen generator 402, that pulls nitrogen gas (N₂) from ambient air. The nitrogen generator 402 may include the nitrogen generator 108 of FIG. 1 and the nitrogen generator 608 of FIG. 6. In embodiments, the nitrogen generator 402 is configured to receive air from the environment. The nitrogen generator 402 may include a duct that is configured to receive air. The nitrogen generator 402 may further include a fan, a compressor, a pump, a vacuum or other methods of creating a pressure differential to move ambient air through the duct, and into the nitrogen generator 402 for processing. The nitrogen generator 402 can include a pressure-swing adsorption (PSA) system, membrane system, and/or cryogenic system for generating nitrogen. In the present disclosure, the terms “pull,” “generate,” “capture”, “separate” and equivalents may be used interchangeably to describe the process for producing N₂ from air, described in more detail below.

PSA systems can include multiple towers which are filled with a carbon molecular sieve (CMS). Compressed air enters the bottom of the towers and flows up through the CMS. Oxygen and other trace gases are preferentially adsorbed by the CMS, allowing nitrogen to pass through. After a pre-set time, the towers can automatically switch to a regenerative mode, venting contaminants from the CMS. CMS differs from ordinary activated carbons as it has a much narrower range of pore openings. This allows small molecules such as oxygen to penetrate the pores and separate from nitrogen molecules which are too large to enter the CMS. The larger nitrogen molecules by-pass the CMS and emerge as nitrogen gas.

Membrane systems are built to separate compressed air through hollow-fiber membranes. Such membrane system work by forcing compressed air into a vessel which selectively permeates oxygen, water vapor, and other impurities out of its sidewalls. Nitrogen flows through the center and emerges as gas. Membrane systems can be easier to operate and can have lower operating costs than PSA and cryogenic systems.

Cryogenic systems start by taking in atmospheric air into an air separation unit. The air is compressed in a compressor and the air components are separated by fractional distillation. Then, the air is moved through a cleanup system where impurities like hydrocarbons, moisture, and carbon dioxide are removed. Next, the air is directed into heat exchangers to liquefy it at cryogenic temperatures. At this stage, the air is put through a high-pressure distillation column where nitrogen is physically separated from oxygen and other gases. Nitrogen so formed is collected and put into a low-pressure distillation column where it is distilled until it meets commercial specifications.

In general, the nitrogen generator 402 can require a significant amount of energy to operate. In embodiments, the nitrogen generator 402 may be configured to receive electricity from a power plant system, such as the power plant 102 of FIG. 1 or the power plant system 750 of FIG. 7. In some aspects of the present technology, the power plant system can flexibly and reliably deliver carbon-free electricity to the nitrogen generator 402. The produced nitrogen gas may be fed to a storage unit, such as a tank, cylinder, pressurized vessel, or the like. The produced nitrogen gas may be fed directly to a downstream process or fed from the storage unit to the downstream process. In embodiments, the nitrogen gas produced by the nitrogen generator 402 is fed to the ammonia production sub-plant 110.

In embodiments, the ammonia production sub-plant 110 receives nitrogen and hydrogen to produce ammonia (NH₃). For example, the ammonia production process 400 utilizes the Haber-Bosch process to convert the hydrogen and the nitrogen to ammonia. The nitrogen and hydrogen may be fed to the ammonia production sub-plant separately, or the two gasses may be combined in a mixed feed stream. The feed stream of nitrogen and hydrogen may be mixed before or after entering the ammonia production sub-plant 110. The nitrogen gas and hydrogen may be configured to be at the same, or nearly the same, pressure for combining into the feed stream. The hydrogen may be received from a hydrogen production process such as the hydrogen production sub-plant 106 and the nitrogen may be received from a nitrogen production process, such as the nitrogen generator 402. In embodiments, the ammonia production sub-plant 110 receives nitrogen from the nitrogen generator 402.

The ammonia production process 400 includes an ammonia synthesis reactor 404 that may convert the hydrogen and nitrogen into ammonia. The primary reaction carried out by the ammonia synthesis reactor 404 is delineated by equation 1, shown below:

$$\begin{matrix}{N}_{2} + 3 {H}_{2} ↔ {2 NH}_{3} & ΔH = - 4 6.14 kJ / mol\end{matrix} \qquad ( 1 )$$

The ammonia synthesis reactor 404 operates at high temperatures and pressures. Operating temperatures may be in a range of 300-500° C. (572-932° F.) and operating pressures may be in a range of 60-180 bar. The nitrogen gas and hydrogen gas feed stream(s) may be pressurized to the operating pressure before entering the ammonia synthesis reactor 404, for example by one or more compressor(s) 406. The compressor 406 may be configured to operate at a steady state, and may include a dynamic compressor, such as a turbo compressor, an axial compressor, a centrifugal compressor, or a mixed compressor. The nitrogen gas and hydrogen gas feed stream(s) may be heated to the operating temperature before entering the ammonia synthesis reactor 404, for example by one or more pre-heater(s) 408. The pre-heater 408 may be configured to operate at a steady state. The pre-heater 408 may be configured to transfer heat from one or more high temperature sources to the nitrogen and hydrogen gas feed stream. The high temperature source may include steam, such as steam from the power plant 102, high temperature process streams within the ammonia production process 400, such as a reactor product stream leaving the ammonia synthesis reactor 404, or high temperature process streams from other processes, such as for example, other processes within the resource production plant 104. The pre-heater 408 may also be configured to heat the nitrogen gas and hydrogen gas feed stream using an electric heater. The power plant 102 may be configured to supply electricity to the electric heater.

The ammonia synthesis reactor 404 may include at least one catalyst. The catalyst may include any compound or material suitable for synthesizing ammonia, such as Iron (Fc), Ruthenium (Ru), and Osmium (Os). For example, the catalyst may include at least one iron catalyst. The Iron (Fe) catalyst may include finely divided iron bound to an iron oxide carrier, such as magnetite, and including one or more promotors including Potassium Oxide (K₂O), Calcium Oxide (CaO), Silicon Dioxide (SiO₂), Aluminum Oxide (Al₂O₃), Potassium Hydroxide (KOH), Molybdenum (Mo), and Magnesium Oxide (MgO).

The product stream leaving the ammonia synthesis reactor 404 includes the ammonia produced in the ammonia synthesis reactor 404 and may also include a portion of unreacted nitrogen and hydrogen gas. The resulting ammonia may be separated from the residual hydrogen and nitrogen gas to produce a pure ammonia product. The boiling point of ammonia gas is significantly higher than that of hydrogen and nitrogen gas, therefore ammonia may be separated from the nitrogen and hydrogen by decreasing the temperature of the reactor product stream to below the boiling point of ammonia, so the ammonia gas will condense into a liquid phase. The reactor product stream will leave the ammonia synthesis reactor 404 at operating temperature and pressure. The reactor product stream may pass through one or more heat exchangers 410 to reduce the temperature of the reactor product stream and to recover heat from the product stream. The one or more heat exchangers 410 may include the pre-heater 408. The reactor product stream may be fed from the one or more heat exchangers 410 to a condenser 412 to separate the ammonia product from the residual hydrogen and nitrogen. The condenser 412 may operate at the same, or nearly the same pressure as the ammonia synthesis reactor 404 and may cool the reactor product stream below the boiling point of ammonia at that pressure, condensing ammonia and separating it from the hydrogen and nitrogen gas. In other embodiments, separation of ammonia may include absorption, for example an absorbent-enhanced Haber-Bosch process that may include metal halides or zeolites. The separated ammonia product may be fed to a storage unit, such as a tank, cylinder, pressurized vessel, or the like. In some cases, the separated ammonia may be fed directly to a downstream process or fed from the storage unit to the downstream process. In embodiments, the ammonia produced by the ammonia production process 400 is fed to the Nitric Acid (HNO₃) sub-plant 112.

Residual hydrogen and nitrogen gas separated from the ammonia product in the condenser 412 may be fed back to the ammonia synthesis reactor 404 to be recycled. The recycle stream of hydrogen and nitrogen may be compressed to operating pressure, for example by a compressor 414. The recycle stream may then be mixed with the hydrogen and nitrogen feed stream at operating pressure prior to entering pre-heater 408. Alternatively, the recycle stream may be fed to the ammonia synthesis reactor 404 separately from the feed stream after passing through one or more compressors 414 and/or pre-heaters to arrive at operating temperature and pressure.

The ammonia production process 400 should not be limited to the embodiment shown in FIG. 4, or the embodiments described above. Determining suitable reaction conditions of the ammonia synthesis reactor 404 and process configurations of heat exchangers, compressors, and process streams is within the ability of one skilled in the art, based on the needs of the skilled artisan. It should be understood that variances in the described process that achieve the same end result should be considered equivalent to the process 400 unless claimed otherwise. For example, while various pressures/temperatures may be utilized for various operations, as discussed throughout in the current disclosure, it is not limited as such. In some instances, other pressures/temperatures suitable for the respective operations may be utilized in a similar way for purposes of implementing the techniques discussed herein.

FIG. 5 is an exemplary schematic diagram illustrating an example Nitric Acid (HNO₃) production process 500 that is configured to produce Nitric Acid (HNO₃). The Nitric Acid (HNO₃) production process 500 may include the Nitric Acid (HNO₃) production sub-plant 112. In accordance with embodiments of the present technology, the Nitric Acid (HNO₃) production process 500 may produce Nitric Acid (HNO₃) according to chemical principles that achieve the function of converting ammonia to Nitric Acid (HNO₃). For example, the Nitric Acid (HNO₃) production process 500 may include the Ostwald process. The overall reaction for the production of Nitric Acid (HNO₃) by the Ostwald process can be delineated by equation 2, shown below:

$$\begin{matrix}2 {NH}_{3} ( g ) + 4 {O}_{2} ( g ) + {H}_{2} O ( l ) ↔ 2 {HNO}_{3} ( a q ) + 3 {H}_{2} O ( g ) \\ ΔH = - 7 \; 40 kJ / mol\end{matrix} \qquad ( 2 )$$

A first stage of the Ostwald process includes the oxidation of ammonia into nitric oxide (NO). The Nitric Acid (HNO₃) production process may include a primary oxidation chamber 502 for the oxidation of ammonia into nitric oxide. The primary oxidation reaction occurs in the presence of a catalyst 504 and can be delineated by equation 3, shown below:

$$\begin{matrix}4 {NH}_{3} ( g ) + 5 {O}_{2} ( g ) ↔ 4 NO ( g ) + 6 {H}_{2} O ( g ) \\ ΔH = - 9 5.2 kJ / mol\end{matrix} \qquad ( 3 )$$

Ammonia may be oxidized by heating with oxygen in the presence of one or more catalyst(s) 504 that support the conversion of ammonia to nitric oxide. The catalyst 504 may include, for example at least one of a platinum gauze catalyst, such as a rhodium-platinum (Pt—Rh) gauze, a copper catalyst, or a nickel catalyst. Oxidization of ammonia is a reversible and exothermic reaction. Therefore, according to Le-Chatelier's principle, a decrease in temperature favors a reaction in the forward direction such that the exothermic reaction will continue as long as both ammonia gas and oxygen are fed into the reaction chamber. Operating conditions for the primary oxidation chamber 502 include a pressure between 4-10 standard atmospheres (405-1,013 kPa; 59-147 psi), and a temperature between about 870-1,073 K (600-800° C.; 1,110-1,500° F.). These conditions may contribute to an overall yield of about 98%.

In embodiments, ammonia, such as the ammonia produced by the ammonia production process 400, is fed to the primary oxidation chamber 502 at operating temperature and pressure of the primary oxidation chamber 502. An oxidizing agent which may include a portion of oxygen, is also fed to the primary oxidation chamber 502. The oxidizing agent may include, for example, pure oxygen gas, such as the oxygen separated from hydrogen in the electrolytic separator 220 of the hydrogen production process 200. In some cases, the oxidizing agent includes air or a combination of air and pure oxygen. In some embodiments, one part of ammonia and eight parts of oxygen by volume are introduced to the primary oxidation chamber. The ammonia and the oxidizing agent may be combined prior to entering the primary oxidation chamber 502 in a single feed stream. In some cases, the ammonia and the oxidizing agent may be fed separately to the primary oxidation chamber 502. The feed stream(s) of ammonia and oxidizing agent may be heated to the operating temperature prior to entering the primary oxidation chamber 502 by one or more pre-heaters. The pre-heater may be configured to operate at a steady state. The pre-heater may be configured to transfer heat from one or more high temperature sources to the ammonia and oxidizing agent feed stream(s). The high temperature source may include steam, such as steam from the power plant 102, high temperature process stream(s) within the Nitric Acid (HNO₃) production process 500, such as a primary chamber product stream leaving the primary oxidation chamber 502, or high temperature process streams from other processes, such as for example, other processes within the resource production plant 104. The pre-heater may also be configured to heat the ammonia and oxidizing agent feed stream(s) using an electric heater. The power plant 102 may be configured to supply electricity to the electric heater.

The feed stream(s) of ammonia and oxidizing agent may be pressurized to the operating pressure prior to entering the primary oxidation chamber 502 by one or more compressors. The compressor may be configured to operate at a steady state, and may include a dynamic compressor, such as a turbo compressor, an axial compressor, a centrifugal compressor, or a mixed compressor. In the primary oxidation chamber 502, the ammonia is oxidized in the presence of catalyst 504 to produce Nitric Oxide (NO). For example, at an operating temperature of about 600° C. and in the presence of a platinum gauze catalyst, 95% of ammonia may be converted into Nitric Oxide (NO) in the primary oxidization chamber 502.

A primary chamber product stream exits the primary oxidation chamber 502 and is cooled to about 150° C. The primary chamber product stream may enter a cooling chamber 506. The cooling chamber 506 may include one or more heat exchangers, and the cooling chamber 506 may be configured to recover heat from the primary chamber product stream, for example by exchanging heat with the ammonia and oxidizing agent feed stream(s). The primary chamber product stream includes the produced Nitric Oxide (NO) and steam (H₂O) along with unreacted ammonia and the oxidizing agent, Oxygen (O₂).

Once cooled, the primary chamber product stream may be fed to a secondary oxidation chamber 508 where NO in the primary chamber product stream may be oxidized to form Nitrogen Dioxide (NO₂) with Oxygen (O₂). The oxidizing agent is pure oxygen gas, such as the oxygen separated from hydrogen in the electrolytic separator 220 of the hydrogen production process 200. In some cases, the oxidizing agent can be air or a combination of air and pure oxygen. Nitric oxide is oxidized to NO₂ in the secondary oxidation chamber 508 at about 50° C. and according to the reaction as delineated by equation 4, shown below:

$$\begin{matrix}2 NO ( g ) + {O}_{2} ( g ) ↔ 2 {NO}_{2} ( g ) & ΔH = - 1 \; 14 kJ / mol\end{matrix} \qquad ( 4 )$$

A secondary chamber product stream exits the secondary oxidation chamber 508. The secondary chamber product stream includes Nitrogen Dioxide (NO₂) produced in the secondary oxidation chamber 508, as well as unreacted Nitric Oxide (NO) and Oxygen (O₂). The secondary chamber product stream may also include unreacted products from the primary chamber product stream, such as H₂O, as well as reaction byproducts.

The secondary chamber product stream may be introduced into an absorption column 510 where nitrogen dioxide produced in the secondary oxidation chamber 508 is converted into Nitric Acid (HNO₃). Nitric Acid (HNO₃) is obtained from the absorption of NO₂ gas in H₂O according to the reaction as delineated by equation 5, shown below in:

$$\begin{matrix}3 {NO}_{2} ( g ) + {H}_{2} O ( g ) ↔ 2 {HNO}_{3} ( g ) + NO ( g ) \\ ΔH = - 1 35.74 kJ / mol\end{matrix} \qquad ( 5 )$$

The absorption column 510 may include one or more packed column or plate column absorption towers. The towers may include a non-reactive quartz bed 516. In the absorption column 510, the NO₂ gas is bubbled through the quartz bed 516 and water 512. The water 512 may be showered over the quartz bed 516 and rising NO₂ gas by a water dispersion device 514. Gases are removed from the absorption column 510 in one or more streams. The one or more gas streams include unreacted NO₂ gas, Nitric Oxide (NO) formed in the absorption reaction of NO₂ and H₂O, unreacted components fed to the absorption column 510 from the secondary oxidation chamber 508, as well as reaction byproducts. At least one gas stream exiting the absorption column 510 may be recycled back to the absorption column 510 to improve NO₂ absorption. At least one gas stream exiting the absorption column 510 may be considered waste and may be sent for waste gas processing.

The Nitric Acid (HNO₃) produced by absorption in the absorption column 510 may be very dilute in water. The HNO₃ may be produced, utilizing the water 512, at any specified level of concentration. For example, the Nitric Acid (HNO₃) production process 500 can be controlled to output the HNO₃ at one level of concentration, and then at another level of concentration, and so on. The aqueous HNO₃ may be removed from the absorption column 510 and may be concentrated by distillation, for example by extractive distillation. Distillation of aqueous HNO₃ may produce HNO₃ concentrated up to about 68% by mass.

Further concentration of the aqueous HNO₃ can be achieved by dehydration with concentrated Sulfuric Acid (H₂SO₄). Concentrated Sulfuric Acid (H₂SO₄) is a dehydrating agent and therefore may absorb water from aqueous HNO₃. In order to increase the concentration of HNO₃, HNO₃ vapors may be passed over the concentrated H₂SO₄ and concentrated HNO₃ of up to 98% may be obtained. The produced Nitric Acid (HNO₃) may be fed to a storage unit, such as a tank, cylinder, pressurized vessel, or the like. The produced Nitrogen gas (N₂) may be fed directly to a downstream process or fed from the storage unit to the downstream process for further use. For example, produced Nitric Acid (HNO₃) may be converted into Ammonium Nitrate (NH₄NO₃), which may then be used in agriculture as a high-nitrogen fertilizer.

The Nitric Acid (HNO₃) production process 500 should not be limited to the embodiment shown in FIG. 5, or the embodiments described above. Determining suitable reaction conditions and catalysts for the conversion of Ammonia (NH₃) to Nitric Acid (HNO₃), and determining the exact configurations of reactors, heat exchangers, compressors, and process streams are within the ability of one skilled in the art, based on the needs of the skilled artisan. It should be understood that variances in the described process that achieve the same end result should be considered equivalent to the process 400 unless claimed otherwise.

FIG. 6 is a schematic diagram of an integrated energy system 600 including the power plant system 750 of FIG. 7, in accordance with additional embodiments of the present technology. In the illustrated embodiment, the integrated energy system 600 is configured to produce “green” Hydrogen (H₂), Oxygen (O₂), Nitrogen (N₂), and Ammonia (NH₃) for use in producing “green” Nitric Acid (HNO₃). Specifically, the power plant system 750 generates electricity and routes the electricity to one or more water production plants 602, one or more auxiliary heaters 604, one or more Hydrogen (H₂) and Oxygen (O₂) production plants 606, one or more Nitrogen (N₂) generators 608, one or more Ammonia (NH₃) production plants 610, and one or more Nitric Acid (HNO₃) production plants 612. In some embodiments, the power plant system 750 can further route electricity (e.g., excess electricity) to a power grid 680. The power plant system 750 further generates steam and routes the steam to the auxiliary heater 604.

The power plant system 750 can be a permanent or temporary installation built at or near the location of the water production plant 602, the auxiliary heater 604, the Hydrogen (H₂) and Oxygen (O₂) production plant 606, the Nitrogen (N₂) generator 608, the Ammonia (NH₃) production plant 610, and/or the Nitric Acid (HNO₃) production plant, or can be a mobile or partially mobile system that is moved to and assembled at or near the location of various components. More generally, the power plant system 750 can be local (e.g., positioned at or near) the industrial processes/operations it supports. For example, the power plant system 750 can be located within 0.4 km (0.25 mile), within 0.8 km (0.5 mile), within 3.22 km (2 miles), within 4.82 km (3 miles), or within 8.1 km (5 miles) of the industrial processes/operations it supports. In some embodiments, the power plant system 750 includes four, six, twelve, or a different number of the nuclear reactors 700 (FIG. 7) and has a power output of between 308-924 megawatts electrical (MWe). In some embodiments, the power plant system 750 can output between about 308-924 MWe and between about 1000-3000 megawatts thermal (MWt).

The water production plant 602 is configured to produce high-quality water and route the produced high-quality water to the integrated energy system 600. The high-quality water may, for example, be routed to the Hydrogen (H₂) and Oxygen (O₂) production plant 606, the power plant system 750, and/or the Nitric Acid (HNO₃) production plant 612.

In some embodiments, the hydrogen and oxygen production plant 606 can (i) utilize high-quality and high-temperature steam generated by the auxiliary heater 604 to generate Hydrogen (H₂) and Oxygen (O₂) using a high temperature steam electrolysis (HTSE) process and/or (ii) utilize high-quality water generated by the water production plant 602 to generate Hydrogen (H₂) and Oxygen (O₂) using a low temperature steam electrolysis (LTSE) process. In embodiments, the Hydrogen (H₂) and Oxygen (O₂) production plant 606 may include the Hydrogen (H₂) production sub-plant 106 and the hydrogen production process 200.

In some cases, the power plant system 750 can use the high-quality water to produce high-quality steam. For example, the produced water can be used as a secondary coolant in a steam generator of one or more of the nuclear reactors 700. In particular embodiments, the Nitric Acid (HNO₃) production plant 612, can use the high-quality water as a reagent in the production of Nitric Acid (HNO₃).

The water production plant 602 can be a water treatment plant, a desalination plant, and/or the like and is configured to produce high-quality water. For example, the water production plant 602 can operate to demineralize and/or otherwise remove contaminants and/or unwanted material from a water source. The water production plant 602 may include, for example, reverse osmosis, electrodialysis, distillation, desalination, deionization, filtration, ultrafiltration, and/or nanofiltration. In general, the water purification plant 602 can require a significant amount of energy to operate. In some aspects of the present technology, the power plant system 750 can flexibly and reliably deliver carbon-free electricity to the water production plant 602.

The Nitrogen (N₂) generator 608 can receive air and utilize the electricity from the power plant system 750 to separate/capture Nitrogen (N₂) from the air. For example, the nitrogen generator 608 can include a pressure-swing adsorption (PSA) system, membrane system, and/or cryogenic system for generating Nitrogen (N₂). In general, the Nitrogen (N₂) generator 608 can require a significant amount of energy to operate. In some aspects of the present technology, the power plant system 750 can flexibly and reliably deliver carbon-free electricity to the nitrogen generator 608. The Nitrogen (N₂) generator 608 may, for example, include the Nitrogen (N₂) generator 108 and the Nitrogen (N₂) generator 402.

The Ammonia (NH₃) production plant 610 can receive Hydrogen (H₂) from the Hydrogen (H₂) and Oxygen (O₂) production plant 606 and Nitrogen (N₂) from the Nitrogen (N₂) generator 608 and utilize the Hydrogen (H₂) and Nitrogen (N₂) to produce Ammonia (NH₃). For example, the Ammonia (NH₃) production plant 610 can carry out the Haber-Bosch process to convert the Hydrogen (H₂) and Nitrogen (N₂) to Ammonia (NH₃). The Ammonia (NH₃) production plant 610 may, for example, include the Ammonia (NH₃) production sub-plant 110.

The Nitric Acid (HNO₃) production plant 612 can receive (i) Hydrogen (H₂) and Oxygen (O₂) from the Hydrogen (H₂) and Oxygen (O₂) production plant 606, (ii) Ammonia (NH₃) from the Ammonia (NH₃) production plant 610, (iii) water from the water production plant 602, and (iv) electricity from the power plant system 750 to generate Nitric Acid (HNO₃) using, for example, the Ostwald process as described above and in FIG. 5.

In some aspects of the present technology, the integrated energy system 600 can produce Nitric Acid (HNO₃) in a highly efficient manner while also producing few or no carbon emissions. In particular, each stage of Hydrogen (H₂), Nitrogen (N₂), Oxygen (O₂), Ammonia (NH₃), and Water (H₂O) production can be powered using electricity and/or steam from the power plant system 750 which utilizes carbon free nuclear energy. In contrast, conventional systems for producing Hydrogen (H₂) for Nitric Acid (HNO₃) production typically rely on Steam-Methane-Reforming process which produces significant carbon emissions. Likewise, processes to produce Nitrogen (N₂) for Ammonia (NH₃) production are energy intensive, and typically rely on energy from burning fossil fuels which further produces significant carbon emissions. Accordingly, the present technology is capable of producing “green” Nitric Acid (HNO₃) by using a sustainable nuclear energy source and green production means. Moreover, the power plant system 750 can be controlled to selectively provide electricity and/or steam to the various components of the integrated energy system 600 based on their demands, operational status, and/or the like, as described in detail in this application, and in reference to FIG. 7 below.

In some embodiments, the integrated energy system 600 can include some features that are at least generally similar in structure and function, or identical in structure and function, to the corresponding features of the integrated energy systems described in detail in U.S. patent application Ser. No. 18/116,819, filed and Mar. 2, 2023, and titled “SMALL MODULAR NUCLEAR REACTOR INTEGRATED ENERGY SYSTEMS FOR ENERGY PRODUCTION AND GREEN INDUSTRIAL APPLICATIONS,” which is incorporated herein by reference in its entirety and attached hereto as appendix A.

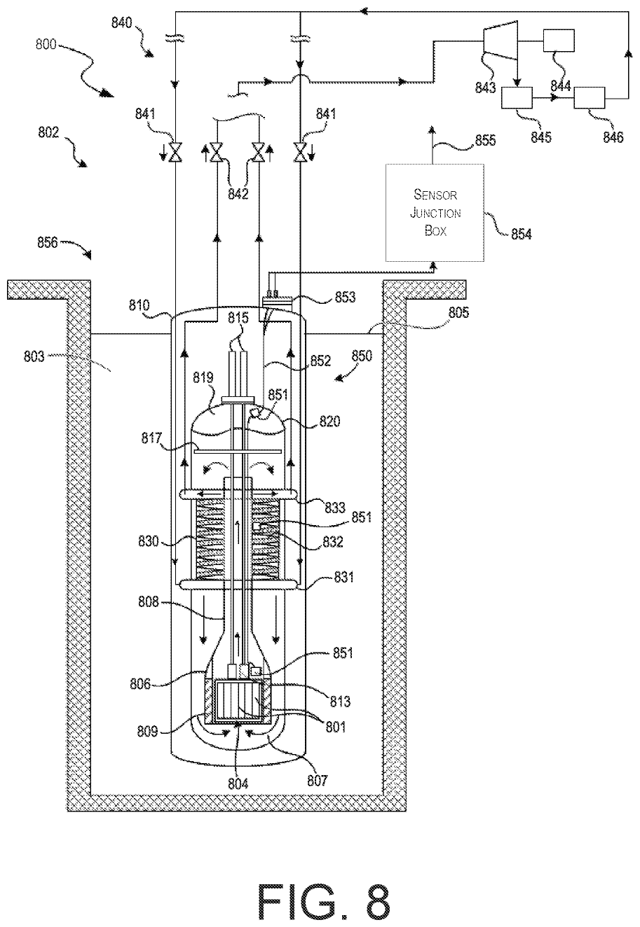

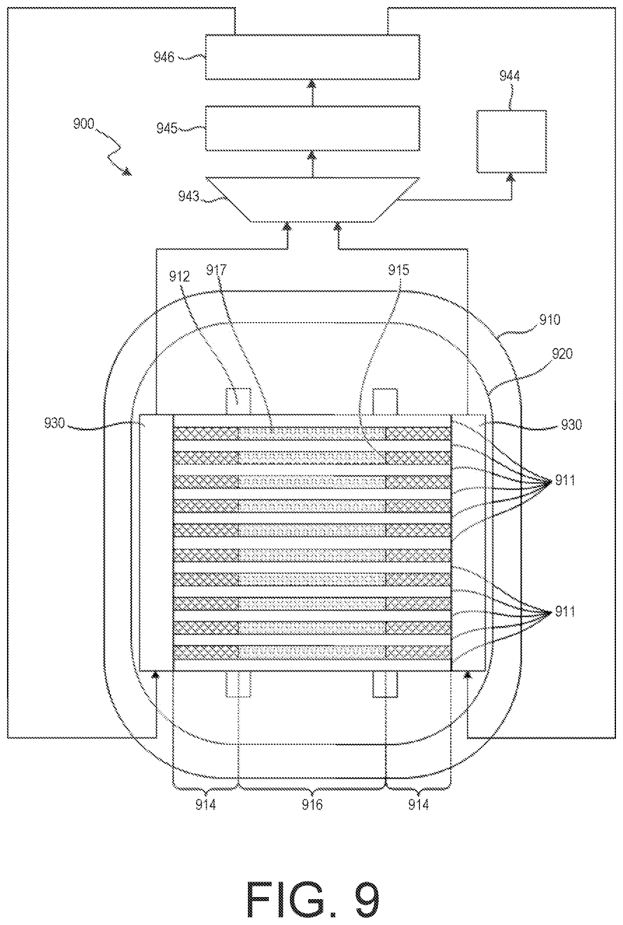

FIG. 7 is a schematic view of a nuclear power plant system 750 (“power plant system 750”) including multiple nuclear reactors 700 (individually identified as first through twelfth nuclear reactors 700a-1, respectively) in accordance with embodiments of the present technology. Each of the nuclear reactors 700 can be similar to or identical to the nuclear reactor system 800 and/or the nuclear reactor system 900 described in detail below with reference to FIG. 8 and FIG. 9. The power plant system 750 can be “modular” in that each of the nuclear reactors 700 can be operated separately to provide an output, such as electricity or steam. In embodiments, the power plant system may include Small Modular Reactors (SMRs). The power plant system 750 can include fewer than twelve of the nuclear reactors 700 (e.g., two, three, four, five, six, seven, eight, nine, ten, or eleven of the nuclear reactors 700), or more than twelve of the nuclear reactors 700. The power plant system 750 can be a permanent installation or can be mobile (e.g., mounted on a truck, tractor, mobile platform, and/or the like). In the illustrated embodiment, each of the nuclear reactors 700 can be positioned within a common housing 751, such as a reactor plant building, and controlled and/or monitored via a control room 752.

Each of the nuclear reactors 700 can be coupled to a corresponding electrical power conversion system 740 (individually identified as first through twelfth electrical power conversion systems 740a-1, respectively). The electrical power conversion systems 740 can include one or more devices that generate electrical power or some other form of usable power from steam generated by the nuclear reactors 700. For example, the electrical power conversion systems 740 can include features that are similar or identical to the power conversion system 840 described in detail below with reference to FIG. 8. In some embodiments, multiple ones of the nuclear reactors 700 can be coupled to the same one of the electrical power conversion systems 740 and/or one or more of the nuclear reactors 700 can be coupled to multiple ones of the electrical power conversion systems 740 such that there is not a one-to-one correspondence between the nuclear reactors 700 and the electrical power conversion systems 740.

The electrical power conversion systems 740 can be further coupled to an electrical power transmission system 754 via, for example, an electrical power bus 753. The electrical power transmission system 754 and/or the electrical power bus 753 can include one or more transmission lines, transformers, and/or the like for regulating the current, voltage, and/or other characteristic(s) of the electricity generated by the electrical power conversion systems 740. The electrical power transmission system 754 can route electricity via a plurality of electrical output paths 755 (individually identified as electrical output paths 755a-n) to one or more end users and/or end uses, such as different electrical loads of an integrated energy system as described in greater detail below.

The power plant system 750 can be configured in a first operating state to provide electricity to the water production plant 602 (e.g., via one or more of the electrical output paths 755 from the electrical power transmission system 754). The water production plant 602 can route the produced high-quality water to the power plant system 750, and the power plant system 750 can use the water to produce high-quality steam. For example, the produced water can be used as a secondary coolant in a steam generator of one or more of the nuclear reactors 700. In some embodiments, the water production plant 602 can be omitted and the power plant system 750 can utilize water from other sources to generate steam.

Each of the nuclear reactors 700 can further be coupled to a steam transmission system 756 via, for example, a steam bus 757. The steam bus 757 can route steam generated from the nuclear reactors 700 to the steam transmission system 756 which in turn can route the steam via a plurality of steam output paths 758 (individually identified as steam output paths 758a-n) to one or more end users and/or end uses, such as different steam inputs of an integrated energy system as described in greater detail below.

In some embodiments, the nuclear reactors 700 can be individually controlled (e.g., via the control room 752) to provide steam to the steam transmission system 756 and/or steam to the corresponding one of the electrical power conversion systems 740 to provide electricity to the electrical power transmission system 754. In some embodiments, the nuclear reactors 700 are configured to provide steam either to the steam bus 757 or to the corresponding one of the electrical power conversion systems 740, and can be rapidly and efficiently switched between providing steam to either. Accordingly, in some aspects of the present technology the nuclear reactors 700 can be modularly and flexibly controlled such that the power plant system 750 can provide differing levels/amounts of electricity via the electrical power transmission system 754 and/or steam via the steam transmission system 756. For example, where the power plant system 750 is used to provide electricity and steam to one or more industrial process-such as various components of the integrated energy systems described in the detail below-the nuclear reactors 700 can be controlled to meet the differing electricity and steam requirements of the industrial processes.

As one example, during a first operational state of an integrated energy system employing the power plant system 750, a first subset of the nuclear reactors 700 (e.g., the first through sixth nuclear reactors 700a-f) can be configured to provide steam to the steam transmission system 756 for use in the first operational state of the integrated energy system, while a second subset of the nuclear reactors 700 (e.g., the seventh through twelfth nuclear reactors 700g-1) can be configured to provide steam to the corresponding ones of the electrical power conversion systems 740 (e.g., the seventh through twelfth electrical power conversion systems 740g-1) to generate electricity for the first operational state of the integrated energy system. Then, during a second operational state of the integrated energy system when a different (e.g., greater or lesser) amount of steam and/or electricity is required, some or all the first subset of the nuclear reactors 700 can be switched to provide steam to the corresponding ones of the electrical power conversion systems 740 (e.g., the seventh through twelfth electrical power conversion systems 740g-1) and/or some or all of the second subset of the nuclear reactors 700 can be switched to provide steam to the steam transmission system 756 to vary the amount of steam and electricity produced to match the requirements/demands of the second operational state. Other variations of steam and electricity generation are possible based on the needs of the integrated energy system. That is, the nuclear reactors 700 can be dynamically/flexibly controlled during other operational states of an integrated energy system to meet the steam and electricity requirements of the operational state.

In contrast, some conventional nuclear power plant systems can typically generate either steam or electricity for output, and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 700 can be individually controlled via one or more operators and/or via a computer system. Accordingly, many embodiments of the technology described herein may take the form of computer-or machine-or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

FIG. 8 and FIG. 9 illustrate representative nuclear reactors that may be included in embodiments of the present technology. FIG. 8 is a partially schematic, partially cross-sectional view of a nuclear reactor system 800 configured in accordance with embodiments of the present technology. The system 800 can include a power module 802 having a reactor core 804 in which a controlled nuclear reaction takes place. Accordingly, the reactor core 804 can include one or more fuel assemblies 801. The fuel assemblies 801 can include fissile and/or other suitable materials. Heat from the reaction generates steam at a steam generator 830, which directs the steam to a power conversion system 840. The power conversion system 840 generates electrical power, and/or provides other useful outputs, such as super-heated steam. A sensor system 850 is used to monitor the operation of the power module 802 and/or other system components. The data obtained from the sensor system 850 can be used in real time to control the power module 802, and/or can be used to update the design of the power module 802 and/or other system components.

The power module 802 includes a containment vessel 810 (e.g., a radiation shield vessel, or a radiation shield container) that houses/encloses a reactor vessel 820 (e.g., a reactor pressure vessel, or a reactor pressure container), which in turn houses the reactor core 804. The containment vessel 810 can be housed in a power module bay 856. The power module bay 856 can contain a cooling pool 803 filled with water and/or another suitable cooling liquid. The bulk of the power module 802 can be positioned below a surface 805 of the cooling pool 803. Accordingly, the cooling pool 803 can operate as a thermal sink, for example, in the event of a system malfunction.

A volume between the reactor vessel 820 and the containment vessel 810 can be partially or completely evacuated to reduce heat transfer from the reactor vessel 820 to the surrounding environment (e.g., to the cooling pool 803). However, in other embodiments the volume between the reactor vessel 820 and the containment vessel 810 can be at least partially filled with a gas and/or a liquid that increases heat transfer between the reactor vessel 820 and the containment vessel 810. For example, the volume between the reactor vessel 820 and the containment vessel 810 can be at least partially filled (e.g., flooded with the primary coolant 807) during an emergency operation.

Within the reactor vessel 820, a primary coolant 807 conveys heat from the reactor core 804 to the steam generator 830. For example, as illustrated by arrows located within the reactor vessel 820, the primary coolant 807 is heated at the reactor core 804 toward the bottom of the reactor vessel 820. The heated primary coolant 807 (e.g., water with or without additives) rises from the reactor core 804 through a core shroud 806 and to a riser tube 808. The hot, buoyant primary coolant 807 continues to rise through the riser tube 808, then exits the riser tube 808 and passes downwardly through the steam generator 830. The steam generator 830 includes a multitude of conduits 832 that are arranged circumferentially around the riser tube 808, for example, in a helical pattern, as is shown schematically in FIG. 8. The descending primary coolant 807 transfers heat to a secondary coolant (e.g., water) within the conduits 832, and descends to the bottom of the reactor vessel 820 where the cycle begins again. The cycle can be driven by the changes in the buoyancy of the primary coolant 807, thus reducing or eliminating the need for pumps to move the primary coolant 807.

The steam generator 830 can include a feedwater header 831 at which the incoming secondary coolant enters the steam generator conduits 832. The secondary coolant rises through the conduits 832, converts to vapor (e.g., steam), and is collected at a steam header 833. The steam exits the steam header 833 and is directed to the power conversion system 840.

The power conversion system 840 can include one or more steam valves 842 that regulate the passage of high pressure, high temperature steam from the steam generator 830 to a steam turbine 843. The steam turbine 843 converts the thermal energy of the steam to electricity via a generator 844. The low-pressure steam exiting the turbine 843 is condensed at a condenser 845, and then directed (e.g., via a pump 846) to one or more feedwater valves 841. The feedwater valves 841 control the rate at which the feedwater re-enters the steam generator 830 via the feedwater header 831. In other embodiments, the steam from the steam generator 830 can be routed for direct use in an industrial process, such as a hydrogen and oxygen production plant, a chemical production plant, and/or the like, as described in detail in this application. Accordingly, steam exiting the steam generator 830 can bypass the power conversion system 840.

The power module 802 includes multiple control systems and associated sensors. For example, the power module 802 can include a hollow cylindrical reflector 809 that directs neutrons back into the reactor core 804 to further the nuclear reaction taking place therein. Control rods 813 are used to modulate the nuclear reaction, and are driven via fuel rod drivers 815. The pressure within the reactor vessel 820 can be controlled via a pressurizer plate 817 (which can also serve to direct the primary coolant 807 downwardly through the steam generator 830) by controlling the pressure in a pressurizing volume 819 positioned above the pressurizer plate 817.

The sensor system 850 can include one or more sensors 851 positioned at a variety of locations within the power module 802 and/or elsewhere, for example, to identify operating parameter values and/or changes in parameter values. The data collected by the sensor system 850 can then be used to control the operation of the system 800, and/or to generate design changes for the system 800. For sensors positioned within the containment vessel 810, a sensor link 852 directs data from the sensors to a flange 853 (at which the sensor link 852 exits the containment vessel 810) and directs data to a sensor junction box 854. From there, the sensor data can be routed to one or more controllers and/or other data systems via a data bus 855.

FIG. 9 is a partially schematic, partially cross-sectional view of a nuclear reactor system 900 (“system 900”) configured in accordance with additional embodiments of the present technology. In some embodiments, the system 900 can include some features that are at least generally similar in structure and function, or identical in structure and function, to the corresponding features of the system 800 described in detail above with reference to FIG. 8, and can operate in a generally similar or identical manner to the system 800.

In the illustrated embodiment, the system 900 includes a reactor vessel 920 and a containment vessel 910 surrounding/enclosing the reactor vessel 920. In some embodiments, the reactor vessel 920 and the containment vessel 910 can be roughly cylinder-shaped or capsule-shaped. The system 900 further includes a plurality of heat pipe layers 911 within the reactor vessel 920. In the illustrated embodiment, the heat pipe layers 911 are spaced apart from and stacked over one another. In some embodiments, the heat pipe layers 911 can be mounted/secured to a common frame 912, a portion of the reactor vessel 920 (e.g., a wall thereof), and/or other suitable structures within the reactor vessel 920. In other embodiments, the heat pipe layers 911 can be directly stacked on top of one another such that each of the heat pipe layers 911 supports and/or is supported by one or more of the other ones of the heat pipe layers 911.

In the illustrated embodiment, the system 900 further includes a shield or reflector region 914 at least partially surrounding a core region 916. The heat pipes layers 911 can be circular, rectilinear, polygonal, and/or can have other shapes, such that the core region 916 has a corresponding three-dimensional shape (e.g., cylindrical, spherical). In some embodiments, the core region 916 is separated from the reflector region 914 by a core barrier 915, such as a metal wall. The core region 916 can include one or more fuel sources, such as fissile material, for heating the heat pipes layers 911. The reflector region 914 can include one or more materials configured to contain/reflect products generated by burning the fuel in the core region 916 during operation of the system 900. For example, the reflector region 914 can include a liquid or solid material configured to reflect neutrons and/or other fission products radially inward toward the core region 916. In some embodiments, the reflector region 914 can entirely surround the core region 916. In other embodiments, the reflector region 914 may partially surround the core region 916. In some embodiments, the core region 916 can include a control material 917, such as a moderator and/or coolant. The control material 917 can at least partially surround the heat pipe layers 911 in the core region 916 and can transfer heat therebetween.

In the illustrated embodiment, the system 900 further includes at least one heat exchanger 930 (e.g., a steam generator) positioned around the heat pipe layers 911. The heat pipe layers 911 can extend from the core region 916 and at least partially into the reflector region 914, and are thermally coupled to the heat exchanger 930. In some embodiments, the heat exchanger 930 can be positioned outside of or partially within the reflector region 914. The heat pipe layers 911 provide a heat transfer path from the core region 916 to the heat exchanger 930. For example, the heat pipe layers 911 can each include an array of heat pipes that provide a heat transfer path from the core region 916 to the heat exchanger 930. When the system 900 operates, the fuel in the core region 916 can heat and vaporize a fluid within the heat pipes in the heat pipe layers 911, and the fluid can carry the heat to the heat exchanger 930. The heat pipes in the heat pipe layers 911 can then return the fluid toward the core region 916 via wicking, gravity, and/or other means to be heated and vaporized once again.

In some embodiments, the heat exchanger 930 can be similar to the steam generator 830 of FIG. 8 and, for example, can include one or more helically-coiled tubes that wrap around the heat pipe layers 911. The tubes of the heat exchanger 930 can include or carry a working fluid (e.g., a coolant such as water or another fluid) that carries the heat from the heat pipe layers 911 out of the reactor vessel 920 and the containment vessel 910 for use in generating electricity, steam, and/or the like. For example, in the illustrated embodiment the heat exchanger 930 is operably coupled to a turbine 943, a generator 944, a condenser 945, and a pump 946. As the working fluid within the heat exchanger 930 increases in temperature, the working fluid may begin to boil and vaporize. The working fluid (e.g., steam) may be used to drive the turbine 943 to convert the thermal potential energy of the working fluid into electrical energy via the generator 944. The condenser 945 can condense the working fluid after it passes through the turbine 943, and the pump 946 can direct the working fluid back to the heat exchanger 930 where it can begin another thermal cycle. In other embodiments, steam from the heat exchanger 930 can be routed for direct use in an industrial process, such as a resource production plant, described in detail above. Accordingly, steam exiting the heat exchanger 930 can bypass the turbine 943, the generator 944, the condenser 945, the pump 946, etc.

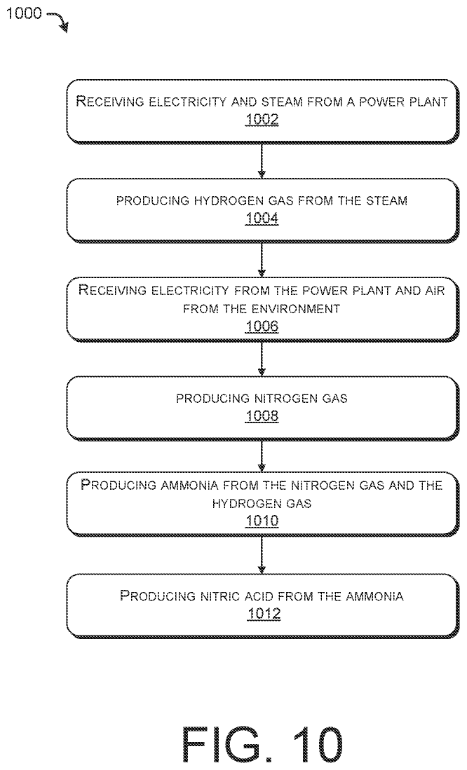

FIG. 10 illustrates and example process for producing Nitric Acid 1000. In various examples, the process can be performed by an Integrated Energy System (IES). The IES may include a power plant, such as the power plant 102 and the power plant system 750. The IES may also include a resource production plant, such as the resource production plant 104. In embodiments, the resource production plant may include the one or more chemical production plants or sub-plants. The resource production plant may include: a hydrogen production process, such as the Hydrogen (H₂) production sub-plant 106, the hydrogen production process 200, and the Hydrogen (H₂) and Oxygen (O₂) production plant 606; a Nitrogen (N₂) production system, such as the Nitrogen (N₂) generator 108, the Nitrogen (N₂) generator 402, and the Nitrogen (N₂) generator 608; an Ammonia (NH₃) production process, such as the Ammonia (NH₃) production sub-plant 110, the Ammonia (NH₃) production process 400, and the Ammonia (NH₃) production plant 610; and a Nitric Acid production process, such as the Nitric Acid production sub-plant 112, the Nitric Acid (HNO₃) production process 500, and the Nitric Acid (HNO₃) production plant 612. In embodiments, the Hydrogen (H₂) production process, the Ammonia (NH₃) production process, and the Nitric Acid (HNO₃) production process are configured to receive electricity from the power plant.

At 1002, electricity and steam are received from a power plant, such as the power plant 102 and the power plant system 750. In embodiments, the power plant produces electricity and steam from nuclear energy. For example, the power plant may include SMRs as described elsewhere in this disclosure. In embodiments, the power plant may be local to the resource production plant. For example, the power plant may be located within 0.4 km (0.25 mile), within 0.8 km (0.5 mile), within 3.22 km (2 miles), within 4.82 km (3 miles), or within 8.1 km (5 miles) of the resource production plant it supports. In embodiments, the power plant is configured to supply a portion of electricity to a power grid.

At 1004, Hydrogen (H₂) gas is produced from the steam received at 1002. In embodiments, the Hydrogen (H₂) gas may be produced by a Hydrogen (H₂) production process, such as the Hydrogen (H₂) production sub-plant 106, the Hydrogen (H₂) production process 200, and the Hydrogen (H₂) and Oxygen (O₂) production plant 606. In embodiments, Hydrogen (H₂) production process may produce Oxygen (O₂) from the steam received produced by the power plant. In embodiments, the Hydrogen (H₂) production process includes electrolysis to separate the Hydrogen (H₂) from Oxygen (O₂) in the steam.

At 1006, electricity is received from the power plant and air is received from the environment. At 1008, nitrogen gas is produced. In embodiments, the electricity from the power plant is used to power a Nitrogen (N₂) generator, such as the nitrogen generator 108, the Nitrogen (N₂) generator 402, and the Nitrogen (N₂) generator 608. In embodiments, the Nitrogen (N₂) is configured to receive the air from the environment and configured to pull the Nitrogen (N₂) from the ambient air.

At 1010, Ammonia (NH₃) is produced from the Nitrogen (N₂) gas produced at 1008 and the Hydrogen (H₂) gas produced at 1004. In embodiments, the Ammonia (NH₃) is produced in an Ammonia (NH₃) production process, such as the Ammonia (NH₃) production sub-plant 110, the Ammonia (NH₃) production process 400, and the Ammonia (NH₃) production plant 610. In embodiments, Ammonia (NH₃) is produced by the Haber-Bosch process.

At 1012, Nitric Acid (HNO₃) is produced from the Ammonia (NH₃). In embodiments, the Nitric Acid (HNO₃) is produced by a Nitric Acid (HNO₃) production process, such as the Nitric Acid (HNO₃) production sub-plant 112, the Nitric Acid (HNO₃) production process 500, and the Nitric Acid (HNO₃) production plant 612. In embodiments, the Nitric Acid (HNO₃) is produced from Oxygen (O₂) produced at 1004 and Ammonia (NH₃) produced at 1010. In embodiments the Nitric Acid (HNO₃) is produced by the Ostwald process. In embodiments, the process for producing Nitric Acid (HNO₃) 1000 uses only the electricity, the steam, ambient air, and water to produce Nitric Acid (HNO₃).

### CONCLUSION

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. An Integrated Energy System (IES), comprising:
a power plant,
a Hydrogen (H₂) production sub-plant that produces Hydrogen (H₂) from steam produced by the power plant,
an Ammonia (NH₃) production sub-plant that produces Ammonia (NH₃) by combining the Hydrogen (H₂) with Nitrogen (N₂) pulled from ambient air, and
a Nitric Acid (HNO₃) production sub-plant that produces Nitric Acid (HNO₃) from the Ammonia (NH₃).

2. The Integrated Energy System (IES) of claim 1, wherein the power plant produces electricity and the steam from nuclear energy.

3. The Integrated Energy System (IES) of claim 2, wherein the power plant comprises one or more Small Modular Nuclear Reactors.

4. The Integrated Energy System (IES) of claim 2, wherein the Hydrogen (H₂) production sub-plant, the Ammonia (NH₃) production sub-plant, and the Nitric Acid (HNO₃) production sub-plant are configured to receive electricity from the power plant.

5. The Integrated Energy System (IES) of claim 1, wherein the Hydrogen (H₂) production sub-plant further produces Oxygen (O₂) from the steam produced by the power plant.

6. The Integrated Energy System (IES) of claim 5, wherein the Nitric Acid (HNO₃) production sub-plant produces the Nitric Acid (HNO₃) from the Oxygen (O₂) and the Ammonia (NH₃) in an Ostwald process.

7. The Integrated Energy System (IES) of claim 1, wherein the Hydrogen (H₂) production sub-plant uses electrolysis to separate the Hydrogen (H₂) from Oxygen (O₂) in the steam.

8. The Integrated Energy System (IES) of claim 1, wherein the Ammonia (NH₃) production sub-plant produces the Ammonia (NH₃) through a Haber-Bosch process.

9. The Integrated Energy System (IES) of claim 1, further comprising a Nitrogen (N₂) generator configured to pull the Nitrogen (N₂) from the ambient air.

10. An integrated Nitric Acid (HNO₃) production system, comprising:
one or more chemical production sub-plants configured to receive at least one of electricity and steam from a power plant, and configured to produce Nitric Acid (HNO₃) using only the electricity, the steam, ambient air, and water.

11. The integrated Nitric Acid (HNO₃) production system of claim 10, wherein the one or more chemical production sub-plants comprise:
a Hydrogen (H₂) production sub-plant configured to produce Hydrogen (H₂),
a Nitrogen (N₂) production sub-plant configured to produce Nitrogen (N₂),
an Ammonia (NH₃) production sub-plant configured to produce Ammonia (NH₃) from the Hydrogen (H₂) and the Nitrogen (N₂), and
a Nitric Acid (HNO₃) production sub-plant configured to produce the Nitric Acid (HNO₃) from the Ammonia (NH₃).

12. The integrated Nitric Acid (HNO₃) production system of claim 10, wherein the power plant is configured to produce the electricity and the steam from nuclear energy.

13. The integrated Nitric Acid (HNO₃) production system of claim 12, wherein the power plant is local to the one or more chemical production sub-plants.

14. The integrated Nitric Acid (HNO₃) production system of claim 12, wherein the power plant is within located within 0.4 km, within 0.8 km, within 3.22 km, within 4.82 km, or within 8.1 km of the one or more chemical production sub-plants.

15. The integrated Nitric Acid (HNO₃) production system of claim 14, wherein the power plant comprises one or more small modular nuclear reactors.

16. The integrated Nitric Acid production system of claim 10, wherein the power plant is configured to supply a portion of electricity to a power grid.

17. A method for producing Nitric Acid (HNO₃), the method comprising:
receiving electricity and steam from a power plant to produce Hydrogen (H₂) gas from the steam,
receiving electricity from the power plant and air from the environment to produce Nitrogen (N₂) gas,
producing Ammonia (NH₃) from the Hydrogen (H₂) gas and the Nitrogen (N₂) gas, and producing Nitric Acid from the Ammonia (NH₃).

18. The method for producing Nitric Acid (HNO₃) of claim 17, wherein the power plant produces the electricity and the steam from nuclear energy and comprises one or more small modular nuclear reactors.

19. The method for producing Nitric Acid (HNO₃) of claim 17, further comprising producing Oxygen (O₂) from the electricity and the steam from the power plant.

20. The method for producing Nitric Acid of claim 19, further comprising producing the Nitric Acid (HNO₃) from the Oxygen (O₂) and the Ammonia (NH₃).
